(19) United States
(12) Patent Application Publication
(10) Pub. No.: US 2005/0018924 A1
(43) Pub. Date: Jan. 27, 2005

(54) Image rectifying mehtod

(76) Inventor: Yen-Cheng Chen, Hsinchu (TW)

Correspondence Address: RABIN & Berdo, PC, 1101 14TH STREET, NW, SUITE 500, WASHINGTON, DC, 20005, US

(21) Appl. No.: 10/876,517

(22) Filed: Jun. 28, 2004

(30) Foreign Application Priority Data
Jul. 21, 2003 (TW) 092119893

(51) Int. Cl. G06K 9/36; G06K 9/32

(52) U.S. Cl. 382/275; 382/300

(57) ABSTRACT

An image rectifying method for an image access device is provided. In the method, at first, an optical resolution is selected. Then, an image of a document is captured to generate a number of original image signals accordingly. Sequentially, according to the optical resolution and a width of the document, the original image signals are modified by a numerical method and then a number of reformed image signals are generated. Finally, the reformed image signals are integrated to generate a rectified image. During image rectifying method of the present invention, numerical methods are used for reducing the distortion caused by color dispersion phenomenon and improving the performance of images.

This application claims the benefit of Taiwan application Serial No. 092119893, filed Jul. 21, 2003, the subject matter of which is incorporated herein by reference.

### BACKGROUND OF THE INVENTION

1. Field of the Invention

The invention relates in general to an image rectifying method, and more particularly to an image rectifying method applied in an image access device using numerical methods.

2. Description of the Related Art

Certain image access devices typically include two or more lenses and a light-sensing module to gather and display images from a document. In order to provide color it is necessary to have the lenses for separating white light rays into a red, a green and a blue light ray. Conventionally, the white light rays were reflected by or partly transmitted through the document, and then they passed through the lenses and were separated into the red, green and blue light rays. Further, the red, green and blue light rays were guided to the light-sensing module and separately received by a red (R), a green (G), and a blue (B) light-sensing unit in the light-sensing module. The light-sensing module includes the red, green, and blue light-sensing unit, each of which has several pixels for sensing various light rays that have different wavelengths and then outputting several original image signals, such as red, green, or blue original image signals. Finally, these various original image signals were integrated to generate an image that can be seen by human eyes.

For light rays traveling from air to an optically dense medium, the light rays that have different wavelengths are all bent toward the normal, but the light ray with greater wavelength has greater refractive angle and less refractive rate. It would be better to say that the wavelength of the red (R) light ray is greater than that of the blue (B) light ray, and then the refractive rate of blue light ray is greater than that of the red light ray. Therefore, different optical image paths are obtained for the red, green and blue light ray when white light rays were separated by the lenses into the red, green and blue light. Also, it is called chromatic dispersion in optics.

FIG. 1A and FIG. 1B are schematic sectional views showing two conventional optical image paths between a document 112, lens 120 and a light-sensing module 122. Both in FIG. 1 and FIG. 2, a width of the document 112 is supposed as “M” inches, and an optical resolution supposed as “N” dot per inch (dpi) is selected by users for an image access device. Therefore, an inference is drawn that there could be M*N dots pixels in a predetermined sensitizing region (Z_{P}) of the R/G/B light-sensing unit for sensing various light rays that have different wavelengths and outputting various original image signals to generate an image.

For example, the optical resolution for the image access device is 600 dpi (N), and the width of the document 112 is 8 inches (M) so that there are 4800 pixels in a predetermined sensitizing region (Z_{P}) of the R/G/B light-sensing unit in theory. The red light rays are received by the pixels in a sensitizing region (Z_{R}) of the red (R) light-sensing unit for outputting several original image signals, and each of the original image signals has an luminance value. Similarly, the green light rays are received by the pixels in a sensitizing region (Z_{G}) of the green (G) light-sensing unit, and the blue light rays are received by the pixels in a sensitizing region (Z_{B}) of the blue (B) light-sensing unit.

When light rays traveling from an optically dense medium to an optically rare medium, as can be seen in FIG. 1, the predetermined sensitizing region Z_{P} is located within the sensitizing region Z_{R}/Z_{G}/Z_{B}. It shows that the amounts of actual pixels in the sensitizing region Z_{R}/Z_{G}/Z_{B} are all more than ones in the predetermined sensitizing region Z_{P} in theory. Here, the amounts of actual pixels in the sensitizing region Z_{R}/Z_{G}/Z_{B} are 4810, 4820, 4830, separately, and the amounts of pixels in the predetermined sensitizing region Z_{P} in theory is 4800.

Contrariwise, when light rays traveling from an optically rare medium to an optically dense medium, as can be seen in FIG. 2, the sensitizing region Z_{R}, Z_{G}, and Z_{B} are all located within the predetermined sensitizing region Z_{P}. It shows that the amounts of actual pixels in the sensitizing region Z_{R}/Z_{G}/Z_{B} are all less than ones in the predetermined sensitizing region Z_{P} in theory. Here, the amounts of actual pixels in the sensitizing region Z_{R}/Z_{G}/Z_{B} are 4790, 4780, 4770, separately, and the amounts of pixels in the predetermined sensitizing region Z_{P} in theory is 4800.

Although the problem of chromatic dispersion can be meliorated by promoting manufacture technology and high quality lens, such high-priced high precision technology will increase the production cost. Also, chromatic dispersion causes image distortion, such as chromatic aberration, so that the performance of images by using the image access device is greatly influenced.

### SUMMARY OF THE INVENTION

In view of the foregoing, it is an object of the present invention to provide an image rectifying method applied in an image access device. In the image rectifying method of the present invention, numerical methods are used for modifying several original image signals corresponding to an optical resolution and a width of a document so that the distortion caused by color dispersion are reduced and performance of images is improved.

An object of the present invention is to provide an image rectifying method for an image access device. At first, an optical resolution is selected. Then, an image of a document is captured to generate a number of original image signals accordingly. Sequentially, according to the optical resolution and a width of the document, the original image signals are modified by a numerical method and then a number of reformed image signals are generated. Finally, the reformed image signals are integrated to generate a rectified image.

Another object of the present invention is to provide an image rectifying method for an image access device. At first, an optical resolution of the image access device is selected to be N. An image of the document, of which the width is M, is captured and then a number of original image signals are generated according to various light rays that have different wavelengths. Each of the original image signals has a luminance value. The optical resolution and a width of the document the luminance values of each of the original image signals are modified to be M*N reformed luminance values by a numerical method. The M*N reformed luminance values which corresponds to each of the original image signals are formed as a reformed image signal. Finally, the reformed image signals are integrated to generate a rectified image.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A and FIG. 1B (Prior Art) are both schematic sectional views showing two conventional optical image paths between a document, lens and a light-sensing module;

FIG. 2 is a flow chart of an image rectifying method according to a preferred embodiment of the invention;

FIG. 3 is a schematic view showing that 11 actual luminance values are modified into 9 reformed luminance values by a linear interpolation method; and

FIG. 4 is a schematic view showing that 9 actual luminance values are modified into 11 reformed luminance values by a linear interpolation method.

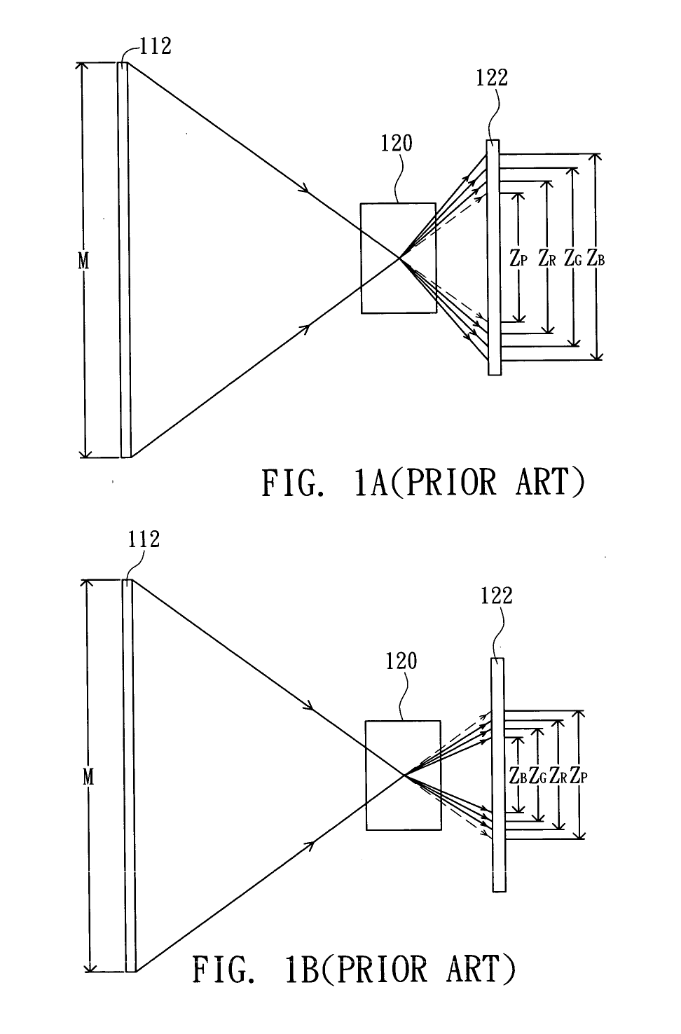

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like components throughout.

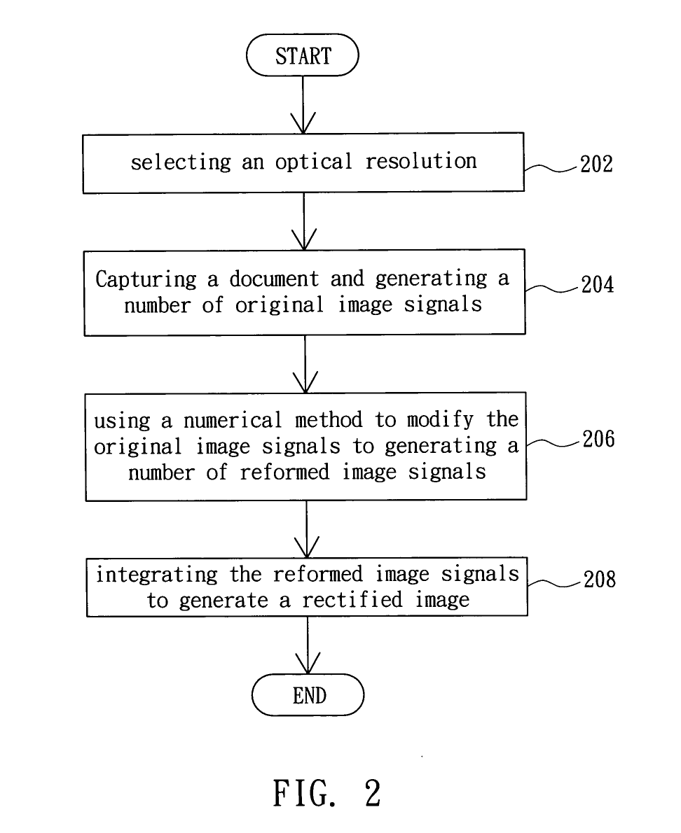

Referring to FIG. 2, it is a flow chart of an image rectifying method according to a preferred embodiment of the invention. At first, as described in step 202, an optical resolution (dot per inch/dpi) is selected by users for an image access device. For example, an optical resolution, N, can be set by users, or “N” preferably can be one of predetermined optical resolution of the image access device. Here, “N” is valued as a positive integer. Then, as described in step 204, a document is scanned and several original image signals corresponding to various light rays that have different wavelengths are obtained. For example, a width of the document is M, and them M*N original image signals are obtained corresponding to various light rays that have different wavelengths. “M” is valued as a positive integer, and these original image signals at least include a red (R), a green (G), and a blue (B) original image signal; each of the original image signals has a luminance value.

Next, as described in step 206, several numerical methods are used to modify the original image signals in order to obtain several reformed image signals. It would be better to say that the numerical methods are used to modify the R/G/B original image signal that has more or less M*N luminance values into a R/G/B reformed image signal that has M*N luminance values in accordance with the optical resolution N and the width of the document M. As described in step 208, the reformed image signals are integrated to generate a rectified image.

The important point to note is that the above-mentioned numerical methods preferably include performing a linear interpolation method, a quadratic interpolation method or other established image signals processing method. Take performing the linear interpolation method as the example, assuming that there are 11 actual luminance values supposed as “H0” to “H10”, but there are only 9 luminance values required in the present invention to integrate into an image, such as 9 reformed luminance values supposed as “K0” to “K8”. Referring to FIG. 3, it is a schematic view showing that 11 actual luminance values are modified into 9 reformed luminance values by the linear interpolation method. Assuming that K0 is equal to H0, and K8 is equal to H10, K1 is obtained by the linear interpolation method in accordance with a formula as below:
K1=H1*(X1)+H2*(X2),
wherein sum of X1 and X2 is equal to 1, and the value of X1 greater than one of X2.

The rest may be deduced by analogy, so that K2 to K7 are similarly obtained by the linear interpolation method. Further, assuming that M, the width of the document, and N, the optical resolution, are respectively equal to 600 and 8, and then red (R), green (G), and blue (B) original image signal separately include 4810, 4820, and 4830 luminance values in practice. According to the above-mentioned numerical method that performs the linear interpolation method, the 4810 luminance values in the red original image signal are modified into a red (R) reformed image signal that has 4800 reformed luminance values by the linear interpolation method. Similarly, the 4820 luminance values in the green original image signal are modified into a green (G) reformed image signal that has 4800 reformed luminance values, and the 4830 luminance values in the blue original image signal are modified into a blue (B) reformed image signal that has 4800 reformed luminance values by the linear interpolation method.

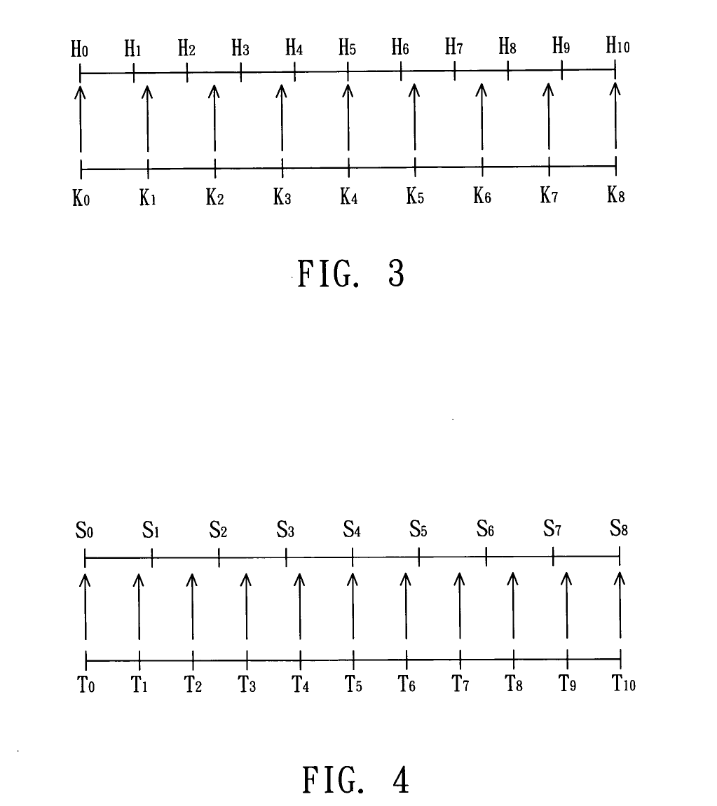

Besides, another case is disclosed that there are only 9 actual luminance values supposed as “S0” to “S8”, but there are 11 luminance values required in the present invention to integrate into an image, such as 11 reformed luminance values supposed as “T0” to “T11”. Referring to FIG. 4, it is a schematic view showing that 9 actual luminance values are modified into 11 reformed luminance values by the linear interpolation method. Assuming that T0 is equal to S0, and T11 is equal to S8, T1 is obtained by the linear interpolation method in accordance with a formula as below:
T1=S0*(U1)+S1*(U2),
wherein sum of U1 and U2 is equal to 1, and the value of U2 greater than one of U1.

The rest may be deduced by analogy, so that T2 to T9 are similarly obtained by the linear interpolation method. Further, assuming that M, the width of the document, and N, the optical resolution, are respectively equal to 600 and 8, and then red (R), green (G), and blue (B) original image signal separately include 4790, 4780, and 4770 luminance values in practice. According to the above-mentioned numerical method that performs the linear interpolation method, the 4790 luminance values in the red original image signal are modified into a red (R) reformed image signal that has 4800 reformed luminance values by the linear interpolation method. Similarly, the 4780 luminance values in the green original image signal are modified into a green (G) reformed image signal that has 4800 reformed luminance values, and the 4770 luminance values in the blue original image signal are modified into a blue (B) reformed image signal that has 4800 reformed luminance values by the linear interpolation method.

However, the present inventions are not limited in what are described above. For example, the image rectifying method disclosed in the preferred embodiment of the present invention is applied in the image access device, such as scanners, fax machines, multi-functional office jets or the like. In addition, all reformed luminance values could not be obtained by the linear interpolation method only. In other words, the linear interpolation method could be employed for two luminance values that are approximate to each other. Simultaneously, a method of selecting critical values or limit values for image signals could be employed for a terminal luminance value in order to prevent vague image borders.

As described hereinbefore, by employing the image rectifying method according to the preferred embodiment of the present invention, numerical methods are applied for modifying the original image signals corresponding to the optical resolution and the width of the document into the reformed image signals that are integrated to generate a rectified image. Moreover, the present invention can reduce the distortion caused by color dispersion so that the performance of images is improved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An image rectifying method for an image access device, comprising:
selecting an optical resolution;
capturing an image of a document to generate a plurality of original image signals accordingly;
using a numerical method to modify the original image signals according to the optical resolution and a width of the document, and then generating a plurality of reformed image signals; and
integrating the reformed image signals to generate a rectified image.

2. The image rectifying method according to claim 1, wherein the numerical method includes a linear interpolation method.

3. The image rectifying method according to claim 1, wherein the numerical method includes a quadratic interpolation method.

4. The image rectifying method according to claim 1, wherein the original image signals are generated according to various light rays that have different wavelengths.

5. The image rectifying method according to claim 4, wherein the original image signals include a red (R) image signal, a green (G) image signal and a blue (B) image signal.

6. The image rectifying method according to claim 1, wherein the optical resolution is a predetermined optical resolution of the image access device.

7. The image rectifying method according to claim 1, wherein prior to the step of integrating the reformed image signals to generate the rectified image, the image rectifying method further comprises:
selecting the optical resolution of the image access device to be N;
using the image access device to capture the image of the document, of which the width is M, wherein the image access device generates the original image signals according to various light rays that have different wavelengths and each of the original image signals has an luminance value; and
using the numerical method to modify the luminance values of each of the original image signals to be M*N reformed luminance values, wherein the M*N reformed luminance values which corresponds to each of the original image signals are formed as one of the reformed image signal.

8. An image rectifying method for an image access device, comprising:
selecting an optical resolution of the image access device to be N;
capturing an image of the document, of which the width is M, and then generating a plurality of original image signals according to various light rays that have different wavelengths, wherein each of the original image signals has an luminance value;
using a numerical method to modify the luminance values of each of the original image signals to be M*N reformed luminance values, wherein the M*N reformed luminance values which corresponds to each of the original image signals are formed as a reformed image signal; and
integrating the reformed image signals to generate a rectified image.

9. The image rectifying method according to claim 8, wherein the numerical method includes a linear interpolation method.

10. The image rectifying method according to claim 8, wherein the numerical method includes a quadratic interpolation method.

11. The image rectifying method according to claim 8, wherein the original image signals include a red (R) image signal, a green (G) image signal and a blue (B) image signal.

12. The image rectifying method according to claim 8, wherein the optical resolution is a predetermined optical resolution of the image access device.
